(19) United States
(12) Patent Application Publication
(10) Pub. No.: US 2005/0210204 A1
(43) Pub. Date: Sep. 22, 2005

(54) Memory control device, data cache control device, central processing device, storage device control method, data cache control method, and cache control method

(75) Inventor: Iwao Yamazaki, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/123,140

(22) Filed: May 6, 2005

Related U.S. Application Data
(63) Continuation of application No. PCT/JP03/00723, filed on Jan. 27, 2003.

(51) Int. Cl. G06F 12/00

(52) U.S. Cl. 711/145; 711/150; 711/144; 711/120

(57) ABSTRACT

A central processing device includes a plurality of sets of instruction processors that concurrently execute a plurality of threads and primary data cache devices. A secondary cache device is shared by the primary data cache device belonging to different sets. The central processing device also includes a primary data cache unit and a secondary cache unit. The primary data cache unit makes an MI request to the secondary cache unit when a cache line with a matching physical address but a different thread identifier is registered in a cache memory, performs an MO/BI based on the request from the secondary cache unit, and sets a RIM flag of a fetch port. The secondary cache unit makes a request to the primary cache unit to perform the MO/BI when the cache line for which MI request is received is stored in the primary data cache unit by a different thread.

### BACKGROUND OF THE INVENTION

1) Field of the Invention

The present invention relates to a memory control device, a data cache control device, a central processing device, a storage device control method, a data cache control method, and a cache control method that process a request to access memory, issued concurrently from a plurality of threads

2) Description of the Related Art

The high-performance processors, which have become commonplace of late, use what is known as an out-of-order process for processing instructions while preserving instruction level parallelism. The out-of-order process involves stalling the process of reading data of an instruction that has resulted in a cache miss, reading the data of a successive instruction, and then going back to reading the data of the stalled instruction.

However, the out-of-order process can produce a Total Store Order (TSO) violation if there is a write involved, in which case, going back and reading the stalled data would mean reading an outdated data. TSO refers to sequence coherency, which means that the read result correctly reflects the sequence in which data is written.

The TSO violation and TSO violation monitoring principle in a multi-processor is explained below with the help of FIG. 9A through FIG. 9C. FIG. 9A is a schematic to explain how the TSO violation is caused. FIG. 9B is a schematic of an example of the TSO violation. FIG. 9C is a schematic to explain the monitoring principle of the TSO violation.

FIG. 9A illustrates an example in which a CPU-β writes to a shared memory area a measurement data computed by a computer, and a CPU-α reads the data written to the shared memory area, analyzes it, and outputs the result of the analysis. The CPU-β writes the measurement data in shared memory area B (changing the data in ST-B from b to b′) and writes to shared memory area A that the measurement data has been modified (changing the data in ST-A from a to a′). The CPU-α confirms by reading the shared memory area A that CPU-β has modified the measurement data (FC-A: A=a′), reads the measurement data in the shared memory area B (FC-B: B=b′), and analyses the data.

In FIG. 9B, assuming the cache of the CPU-α only has the shared memory area B and the cache of the CPU-β only has the shared memory area A, when the CPU-α executes FC-A, a cache miss results, prompting the CPU-α to hold the execution of FC-A until the cache line on which A resides reaches the CPU-α, meanwhile executing FC-B, which produces a hit. FC-B reads data in the shared memory area B prior to modification by the CPU-β (CPU-α: B=b).

In the meantime, to execute ST-B and ST-A, the CPU-β acquires exclusive control of the cache lines on which B and A reside, and either invalidates the cache line on which B of the CPU-α resides or throws out the data (MO/BI: Move Out/Block Invalidate). When the cache line on which B resides reaches the CPU-β, the CPU-β completes data writing to B and A (CPU-β: B=b′ and A=a′), after which the CPU-α accepts the cache line on which A resides (MI: Move In) and completes FC-A (CPU-α: A=a′). Thus, the CPU-α incorrectly judges from A=a′ that the measurement data is modified, and uses the outdated data (B=b) to perform a flawed operation.

Therefore, conventionally, the possibility of a TSO violation is detected by monitoring the invalidation or throwing out of the cache line that includes the data B which is executed first and the arrival of the cache line that includes the data A which is retrieved later, and if the possibility of TSO violation is detected, execution of the instruction next to the fetch instruction from which the sequence is preserved is carried out, thereby preventing any TSO violation.

To be specific, the fetch requests from the instruction processor are received at the fetch ports of the memory control device. As shown in FIG. 9C, each of the fetch ports maintains the address from where data is to be retrieved, a Post STatus Valid (PSTV) flag, a Re-Ifetch by Move out (RIM) flag, and a Re-Ifetch by move in Fetch (RIF) flag. Further, the fetch ports also have set in them a Fetch Port Top of Queue (FP-TOQ) that indicates the oldest assigned fetch port among the fetch ports from where data has not been retrieved in response to the fetch requests from the instruction processor.

The instant FC-B of the CPU-α retrieves, the PSTV flag of the fetch port that receives the request of FC-B is set. The shaded portion in FIG. 9C indicates the fetch ports where the PSTV flag is set. Next, the cache line that use FC-B are invalidated or thrown out by ST-B of the CPU-β. At this time, it can detected that the cache line of the fetch port from where data is sent has arrived if the PSTV flag of the fetch port that receives the request of FC-B is set and the physical address portion of the address maintained in the fetch port matches with the physical address of the address where the invalidation request or a cache line throw out request is received.

Upon detection of arrival of the cache line of the fetch port that sends the data, RIM flag is set for all the fetch ports from the fetch port that maintains the request of FC-B up to the fetch port that indicates PF-TOQ.

When the CPU-α receives from the CPU-β the cache line on which A resides in order for the CPU-β to execute ST-B and THE CPU-α to execute FC-A, the CPU-α detects that data has been received from outside, and sets the RIF flag for all the valid fetch ports. Upon checking the RIM flag and the RIF flag of the fetch port that maintains the request of FC-A for notifying the instruction processor that execution of FC-A has been successful, both the RIM flag and the RIF flag are set. Therefore the instruction next to FC-A is re-executed.

In other words, if both the RIM flag and the RIF flag are set, it indicates that there is a possibility that data b, which was sent in response to the fetch request B made later, has been modified to b′ by another instruction processor and that the data retrieved by the earlier fetch request A is a modified data a′.

Thus, TSO violation between processors in a multi-processor environment can be prevented by setting the PSTV flag, RIM flag, and RIF flag on the fetch ports, and monitoring the shuttling of the cache lines between the processors. U.S. Pat. No. 5,699,538 discloses a technology that assures preservation of TSO between the processors. Japanese Patent Laid-Open Publication Nos. H10-116192, H10-232839, 2000-259498, and 2001-195301 disclose technology relating to cache memory.

However, ensuring TSO preservation between the processors alone is inadequate in a computer system implementing a multi-thread method. A multi-thread method refers to a processor concurrently executing a plurality of threads (instruction chain). In other words, in a multi-thread computer system, a primary cache is shared between different threads. Thus, apart from monitoring the shuttling of the cache lines between processors, it is necessary to monitor the shuttling of the cache lines between the threads of the same cache.

### SUMMARY OF THE INVENTION

It is an object of the present invention to at least solve the problems in the conventional technology.

A memory control device according to an aspect of the present invention is shared by a plurality of threads that are concurrently executed, and that processes memory access requests issued by the threads. The memory control device includes a coherence ensuring unit that ensures coherence of a sequence of execution of reading and writing of data by a plurality of instruction processors, wherein the data is shared between the instruction processors; a thread determining unit that, when storing data belonging to an address specified in the memory access request, determines whether a first thread and a second thread are the same, wherein the thread is a thread that has registered the data and the second thread is a thread that has issued the memory access request; and a coherence ensuring operation launching unit that activates the coherence ensuring unit based on a determination result of the thread determining unit.

A data cache control device according to another aspect of the present invention is shared by a plurality of threads that are concurrently executed and that processes memory access requests issued by the threads. The data cache control device includes a coherence ensuring unit that ensures coherence of a sequence of execution of reading and writing of data by a plurality of instruction processor, wherein the data is shared between the instruction processors; a thread determining unit that, when storing a cache line that includes data belonging to an address specified in the memory access request, determines where a first thread and a second thread are the same, wherein the first thread is a thread that has registered the cache line and the second thread is a thread that has issued the memory access request; and a coherence ensuring operation launching unit that actives the coherence ensuring unit when the thread determining unit determines that the first thread and the second thread are not the same.

A central processing device according to still another aspect of the present invention includes a plurality of sets of instruction processors that concurrently execute a plurality of threads and primary data cache devices, and a secondary cache device that is shared by the primary data cache devices belonging to different sets. Each primary data cache device comprises a coherence ensuring unit that ensures coherence in a sequence of execution of reading from the cache line and writing to the cache line by the plurality of instruction processors, the cache line being shared with the primary data cache devices belonging to other sets; a retrieval request unit that makes to the secondary cache device a cache line retrieval request when the cache line belonging to a physical address that matches with the physical address in the memory access request from the instruction processor; and a throw out execution unit that activates the coherence ensuring unit by invalidating or throwing out the cache line based on a request from the secondary cache device. The secondary cache device includes a throw out requesting unit that, when the cache line retrieval request is registered in the primary data cache device by another thread, makes to the primary data cache device the request to invalidate or throw out the cache line.

A memory control device according to still another aspect of the present invention is shared by a plurality of threads that are concurrently executed and that processes memory access requests issued by the threads. The memory control device includes an access invalidating unit that, when the instruction processor switches threads, invalidates from among store instructions and fetch instructions issued by the thread being inactivated, all the store instructions and fetch instructions that are not committed; and an interlocking unit that, when the inactivated thread is reactivated, detects the fetch instructions that are influenced by the execution of the committed store instructions, and exerts control in such a way that the detected fetch instructions are executed after the store instructions.

A memory device control method according to still another aspect of the present invention is a method for processing memory access requests issued from concurrently executed threads. The memory device control method includes determining, when storing data belonging to an address specified in the memory access request, whether a first thread is the same as a second thread, wherein the first thread is a thread that has registered the data and the second thread is a thread that has issued the memory access request; and activating a coherence ensuring mechanism that ensures coherence in a sequence of execution of reading and writing of the data by a plurality of instruction processors, wherein the data is shared between the instruction processors.

A data cache control method according to still another aspect of the present invention is a method for processing memory access requests issued from concurrently executed threads. The data cache control method includes determining, when storing a cache line that includes data belonging to an address specified in the memory access request, whether a first thread is the same as a second thread, wherein the first thread is a thread that has registered the cache line and the second thread is a thread that has issued the memory access request; and activating a coherence ensuring mechanism that ensures coherence in a sequence of execution of reading and writing of the data by a plurality of instruction processors, wherein the data is shared between the instruction processors.

A cache control method according to still another aspect of the present invention is used by a central processing device that includes a plurality of sets of instruction processors that concurrently execute a plurality of threads and primary data cache devices, and a secondary cache device that is shared by the primary data cache devices belonging to different sets. The cache control method includes each of the primary data cache device making to the secondary cache device a cache line retrieval request when the cache line belonging to a physical address that matches with the physical address in the memory access request from the instruction processor; the secondary cache device performing throwing-out, when the cache line retrieval request is registered in the primary data cache device by another thread, the secondary cache device makes to the primary cache device a request to invalidate or throw out the cache line; and the primary data cache device activating, by invalidating or throwing out the cache line based on the request from the secondary cache device, the coherence ensuring mechanism that ensures coherence of a sequence of execution of reading of and writing to the cache line by a plurality of instruction processors, the cache line being shared by the primary data cache device belonging to other sets.

A data cache control method according to still another aspect of the present invention is a method for processing memory access requests issued from concurrently executed threads. The memory device control method includes invalidating, when the instruction processor switches threads, from among store instructions and fetch instruction issued by the thread being inactivated, all the store instructions and fetch instructions that are not committed; and detecting, when the inactivated thread is reactivated, the fetch instructions that are influenced by the execution of the committed store instructions, and executing control in such a way that the detected fetch instructions are executed after the store instructions.

The other objects, features, and advantages of the present invention are specifically set forth in or will become apparent from the following detailed description of the invention when read in conjunction with the accompanying drawings.

### BRIEF DESCRIPTION OF THE DRAWINGS

FIG. 1 is a functional block diagram of a CPU according to a first embodiment of the present invention;

FIG. 2 is an exemplary a cache tag;

FIG. 3 is a flowchart of a process sequence of a cache controller shown in FIG. 1;

FIG. 4 is a flowchart of a process sequence of an MI process between the cache controller and a secondary cache unit;

FIG. 5 is a functional block diagram of a CPU according to a second embodiment of the present invention;

FIG. 6 is a drawing illustrating an operation of the cache controller according to the second embodiment;

FIG. 7 is a flowchart of a process sequence of the cache controller according to the second embodiment;

FIG. 8 is a flowchart of a process sequence of a MOR process; and

FIG. 9A through FIG. 9C are drawings illustrating a TSO violation and TSO violation monitoring principle in a multi-processor.

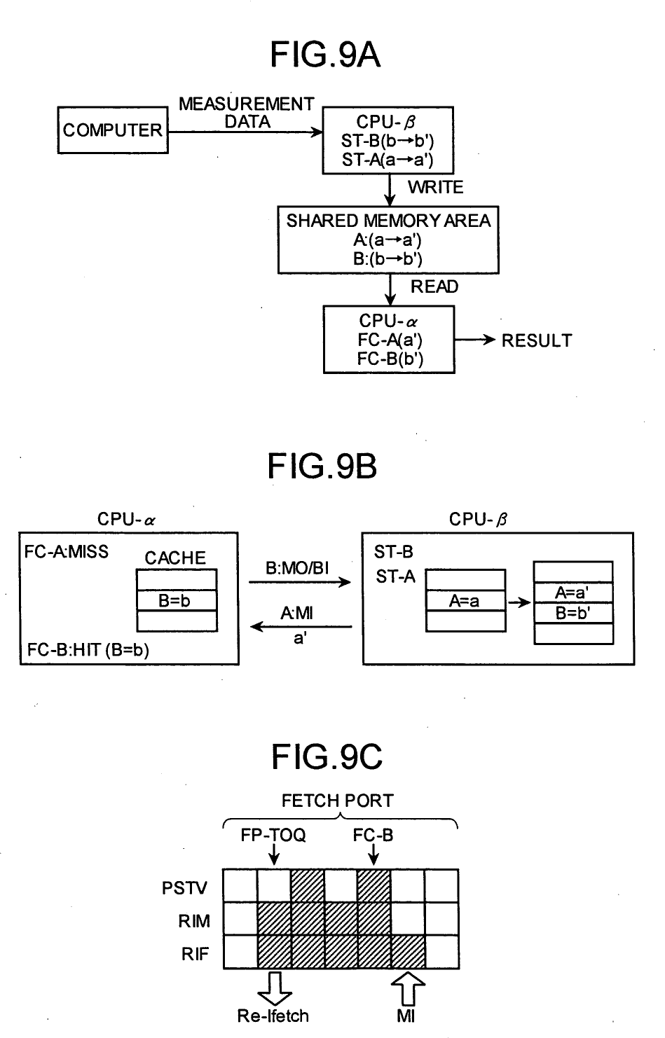

### DETAILED DESCRIPTION

Exemplary embodiments of the present invention are explained next with reference to the accompanying drawings. According to the present invention, TSO is ensured between threads being executed by difference processors by the conventional method of setting the RIM flag by the invalidation/throwing out of the cache line and by setting the RIF flag due to the arrival of data. Ensuring TSO between threads being concurrently executed by the same processor is explained here.

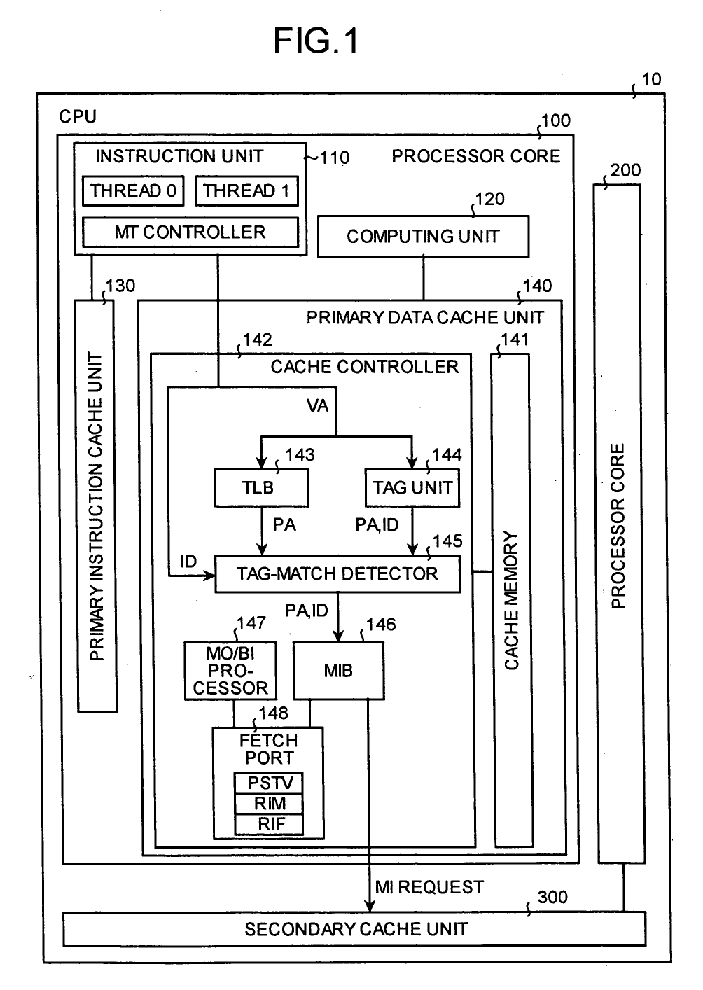

The structure of a central processing unit (CPU) according to a first embodiment of the present invention is explained first. FIG. 1 is a functional block diagram of a CPU 10 according to the first embodiment. The CPU 10 includes processor cores 100 and 200, and a secondary cache unit 300 shared by both the processor cores 100 and 200.

Though the number of processor cores may range from one to several, in this example the CPU 10 is shown to include only two processor cores for the sake of convenience. Since both the processor cores 100 and 200 have a similar structure, the processor core 100 is taken as an example for explanation.

The processor core 100 incorporates an instruction unit 110, a computing unit 120, a primary instruction cache unit 130, and a primary data cache unit 140.

The instruction unit 110 deciphers and executes an instruction, and controls a multi-thread (MT) controller with two threads, namely thread 0 and thread 1 and concurrently executes the two threads.

The computing unit 120 incorporates common register, floating point register, fixed point computing unit, floating point computing unit, etc. and is a processor that executes the fixed point computing unit and the floating point computing unit.

The primary instruction cache unit 130 and the primary data cache unit 140 are storage units that store a part of a main memory device in order to quickly access instructions and data, respectively.

The secondary cache unit 300 is a storage unit that stores more instructions and data of the main memory to make up for inadequate capacity of the primary instruction cache unit 130 and the primary data cache unit 140, respectively.

The primary data cache unit 140 is explained in detail next. The primary data cache unit 140 includes a cache memory 141 and a cache controller 142. The cache memory 141 is a storage unit in which data is stored.

The cache controller 142 is a processing unit that manages the data stored in the cache memory 141. The cache controller 142 includes a Translation Look-aside Buffer (TLB) 143, a TAG unit 144, a TAG-MATCH detector 145, a Move In Buffer (MIB) 146, an MO/BI processor 147, and a fetch port 148.

The TLB 143 is a processing unit that quickly translates a virtual address (VA) to a physical address (PA). The TLB 143 translates the virtual address received from the instruction unit 110 to a physical address and outputs the physical address to the TAG-MATCH detector 145.

The TAG unit 144 is a processor that manages cache lines in the cache memory 141. The TAG unit 144 outputs to the TAG-MATCH detector 145 the physical address of the cache line in the cache memory 141 that corresponds to the virtual address received from the instruction unit 110, a thread identifier (ID), etc. The thread identifier refers to an identifier for distinguishing between the thread the cache line is using, that is, between thread 0 and thread 1.

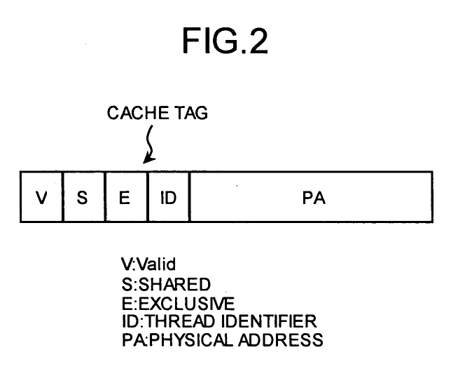

FIG. 2 is a drawing of an example of a cache tag, which is information the TAG unit 144 requires for managing the cache line in the cache memory 141. The cache tag consists of a V bit that indicates whether the cache line is valid, an S bit and an E bit that respectively indicate whether the cache line is shared or exclusive, an ID that indicates the thread used by the cache line, and a physical address that indicates the physical address of the cache line. When the cache line is shared, it indicates that the cache line may be concurrently shared by other processors. When the cache line is exclusive, it indicates that the cache line at a given time belongs to only one processor and cannot be shared.

The TAG-MATCH detector 145 is a processing unit that compares the physical address received from the TLB 143 and a thread identifier received from the instruction unit 110 with the physical address and the thread identifier received from the TAG unit 144. If the physical addresses and the thread identifiers match and the V bit is set, the TAG-MATCH detector 145 uses the cache line in the cache memory 141. If the physical addresses and the thread identifiers do not match, the TAG-MATCH detector 145 instructs the MIB 146 to specify the physical address and retrieve the cache line requested by the instruction unit 110 from the secondary cache unit 300.

By comparing not only the physical address received from the TLB 143 and the physical address received from the TAG unit 144 but also the thread identifier received from the instruction unit 110 and the thread identifier received from the TAG unit 144, the TAG-MATCH detector 145 is not only able to determine whether the cache line requested by the instruction unit 110 is present in the cache memory, but also whether the thread that requests the cache line and the thread that has registered the cache line in the cache memory 141 are the same, and based on the result of determination, carries out different processes.

The MIB 146 is a processing unit that specifies the physical address in the secondary cache unit 300 and requests for a cache line retrieval (MI request). The cache tag of the TAG unit 144 and the contents of the cache memory 141 are modified corresponding to the cache line retrieved by the MIB 146.

The MO/BI processor 147 is a processing unit that invalidates or throws out a specific cache line of the cache memory 141 based on the request from the secondary cache unit 300. The invalidation or throwing out of the specific cache line by the MI/BI processor 147 causes the setting of the RIM flag at the fetch port 148. As a result, the mechanism for ensuring TSO between the processors can be used as a mechanism for ensuring TSO between the threads.

The fetch port 148 is a storage unit that stores the address of access destination, the PSTV flag, the RIM flag, the RIF flag, etc. for each access request issued by the instruction unit 110.

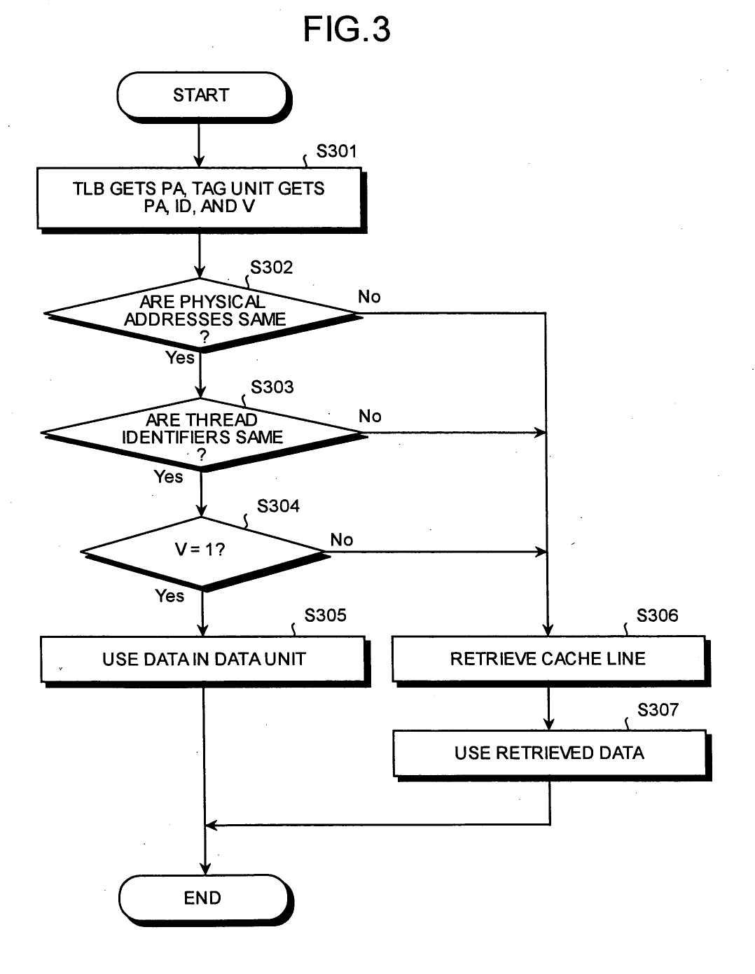

A process sequence of the cache controller 142 shown in FIG. 1 is explained next. FIG. 3 is a flowchart of the process sequence of the cache controller 142 shown in FIG. 1. The TLB 143 of the cache controller 142 translates the virtual address to the physical address, and the TAG unit gets the physical address, the thread identifier, and the V bit from the virtual address using the cache tag (step S301).

The TAG-MATCH detector 145 compares the physical address received from the TLB 143 and the physical address received from the TAG unit 144, and determines whether the cache line requested by the instruction unit 110 is present in the cache memory 141 (step S302). If the two physical addresses are the same, the TAG-MATCH detector 145 compares the thread identifier received from the instruction unit 110 and the thread identifier received from the TAG unit 144, and determines whether the cache line in the cache memory 141 is used by the same thread (step S303).

If the two thread identifiers are found to be the same, the TAG-MATCH detector determines whether the V bit is set (step S304). If the V bit is set, since it indicates that the cache line requested by the instruction unit 110 is present in the cache memory 141, and the cache line is valid as the thread is the same, the cache controller 142 uses the data in the data unit (step S305).

If the physical addresses and the thread identifiers do not match, and the V bit is not set, since it either indicates that no cache line is present in the cache memory 141 having the physical address that matches the physical address of the cache line requested by the thread executed by the instruction unit 110, or that even if the physical addresses match, the cache line is used by different threads, or that the cache line is invalid, the data in the cache memory 141 cannot be used. As a result, the MIB 146 retrieves the cache line from the secondary cache unit 300 (step S306). The cache controller 142 then uses the data in the cache line retrieved by the MIB 146 (step S307).

Thus, the cache controller 142 is able to control the cache line between the threads due to the TAG-MATCH detector 145 determining not only whether the physical address match, but also whether the thread identifiers match.

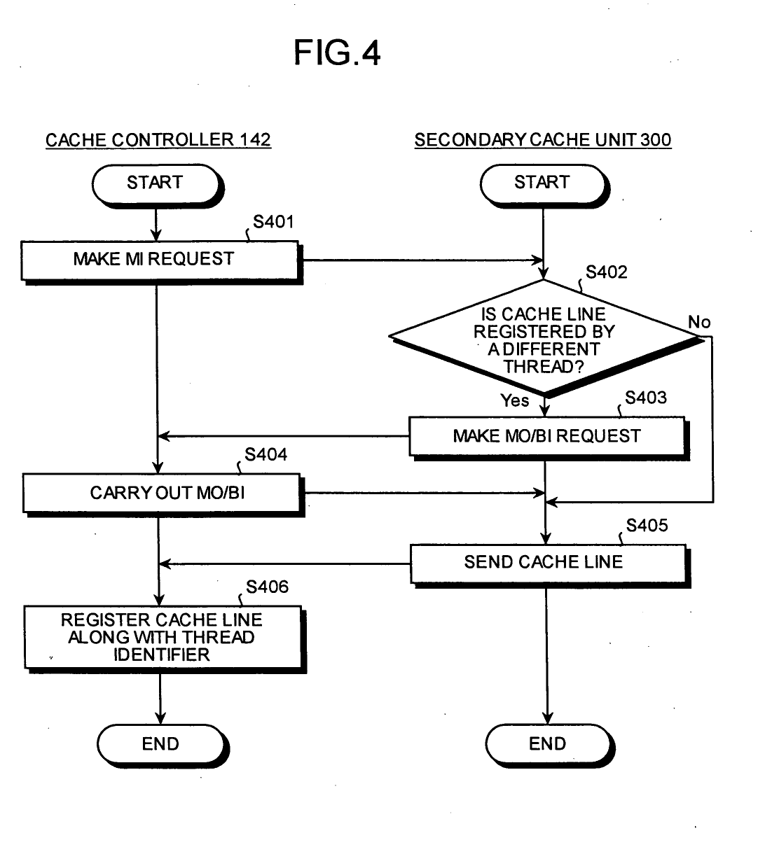

A process sequence of fetching of the cache line (MI process) between the cache controller 142 and the secondary cache unit 300 is explained next. FIG. 4 is a flowchart of the process sequence of the MI process between the cache controller 142 and the secondary cache unit 300. The MI process corresponds to step S306 of the cache controller 142 shown in FIG. 3 and the process by the secondary cache unit 300 corresponding to step S306.

The cache controller 142 of the primary data cache unit 140 first makes an MI request to the secondary cache unit 300 (step S401). In response, the secondary cache unit 300 determines whether the cache line for which MI request has been made is registered in the primary data cache unit 140 by a different thread (step S402). If the requested cache line is registered by a different thread, the secondary cache unit 300 makes a MO/BI request to the cache controller 142 in order to set the RIM flag (step S403).

The secondary cache unit 300 determines whether the requested cache line is registered in the primary data cache unit 140 by a different thread by means of synonym control. Synonym control is a process of managing at the secondary cache unit the addresses registered in the primary cache unit in such a way that no two cache lines have the same physical address.

The MO/BI processor 147 of the cache controller 142 carries out the MO/BI process and sets the RIM flag (step S404). Once the RIM flag is set, the secondary cache unit 300 sends the cache line (step S405) to the cache controller 142. The cache controller 142, registers the received cache line along with the thread identifier (step S406). Once the cache line arrives, the RIF flag is set.

If the cache line is not registered in the primary data cache unit 140 by a different thread, the secondary cache unit 300 sends the cache line to the cache controller 142 without carrying out the MO/BI request (step S405).

Thus, in the MI process, the secondary cache unit 300 carries out a synonym control to determine whether the cache line for which MI request is made is registered in the primary data cache unit 140 by a different thread. If so, the MI/BI processor 147 of the cache controller 142 carried out the MO/BI process in order to set the RIM flag. As a result, the mechanism for ensuring TSO between the processors can be used as a mechanism for ensuring TSO between the threads.

Thus, in the first embodiment, even if the cache memory 141 has the cache line whose physical address matches with the physical address of the requested cache line but whose thread identifier does not match with the thread address of the requested cache line, the TAG-MATCH detector 145 of the primary data cache unit 140 makes an MI request to the secondary cache unit 300. If the cache line for which MI request is received is registered in the primary data cache unit 140 by a different thread, the secondary cache unit 300 makes an MO/BI request to the cache controller 142. The cache controller 142 then carries out the MO/BI process and sets the RIM flag of the fetch port 148. As a result, the mechanism for ensuring TSO between the processors can be used as a mechanism for ensuring TSO between the threads.

In the present invention, the secondary cache unit 300 makes an MO/BI request to the primary data cache unit by means of synonym control. Synonym control increases the load on the secondary cache unit 300. Therefore, there are instances where synonym control is not used by the secondary cache unit. In such cases, when the cache lines having the same physical address but different thread identifiers registered in the cache memory, the primary data cache unit carries out the MO/BI process by itself. As a result, TSO between the threads can be ensured.

When MO/BI process is done at the primary data cache unit end, a conventional protocol involving making a request for throwing out cache lines from the primary cache unit to the secondary cache unit is used for speeding up data transfer from the processor and an external storage device. In this protocol, a cache line throw out request for throwing out the cache lines is sent from the primary cache unit to the secondary cache unit. Upon receiving the cache line throw out request, the secondary cache unit forwards the request to the main memory control device, and based on the instruction from the main memory control device, throws out the cache lines to the main memory device. Thus, the cache lines can be thrown out of the primary cache unit to the secondary cache unit by means of this cache line throw out operation.

### SECOND EMBODIMENT

In the first embodiment, the RIM flag of the fetch port was set with the aid of synonym control of the secondary cache unit or a cache line throw out request by the primary data cache unit. However, the secondary cache unit may not have a mechanism for carrying out synonym control, and the primary data cache unit may not have a mechanism for carrying out cache line throw out request.

Therefore, in a second embodiment of the present invention, TSO is ensured by monitoring the throwing out/invalidation process of replacement blocks produced during the replacement of the cache lines or by monitoring access requests for accessing the cache memory or the main storage device. Since primarily the operation of the cache controller in the second embodiment is different from the first embodiment, the operation of the cache controller is explained here.

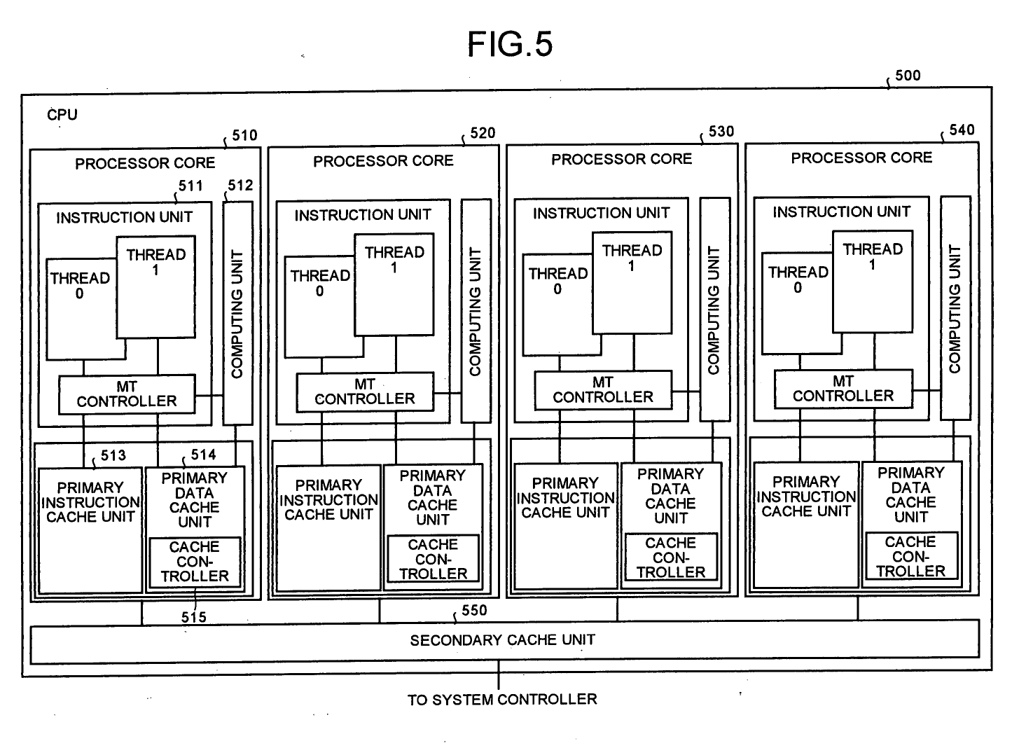

The structure of a CPU according to the second embodiment is explained next. FIG. 5 is a functional block diagram of the CPU according to the second embodiment. A CPU 500 includes four processor cores 510 through 540, and a secondary cache unit 550 shared by the processor cores 510 through 540. Since all the processor cores 510 through 540 have a similar structure, the processor core 510 is taken as an example for explanation.

The processor core 510 includes an instruction unit 511, a computing unit 512, a primary instruction cache unit 513, and a primary data cache unit 514.

The instruction unit 511, like the instruction unit 110, deciphers and executes an instruction, and controls a multi-thread (MT) controller with two threads, namely thread 0 and thread 1 and concurrently executes the two threads.

The computing unit 512, like the computing unit 120, is a processor that executes the fixed point computing unit and the floating point computing unit. The primary instruction cache unit 513, like the primary instruction cache unit 130, is a storage unit that stores a part of the main memory device in order to quickly access instructions.

The primary data cache unit 514, like the primary data cache unit 140, is a storage unit that stores a part of the main memory device in order to quickly access data. A cache controller 515 of the primary data cache unit 514 does not, like the cache controller 142 according to the first embodiment, make an MI request to the secondary cache unit 550 when cache lines having the same physical address but different identifiers are registered in the cache memory. Instead, the cache controller 515 carries out a replace move out (MOR) process on the cache lines having the same physical address and modifies the thread identifier registered in the cache tag.

The cache controller 515 monitors the fetch port throughout the replace move out process and sets the RIM flag and the RIF flag if address matches. However, RIF flag can also be set when different threads issue a write instruction to the cache memory or the main memory device. The cache controller 515 ensures STO by requesting re-execution of the instruction when the fetch port at which both RIM flag and RIF flag are set returns STV.

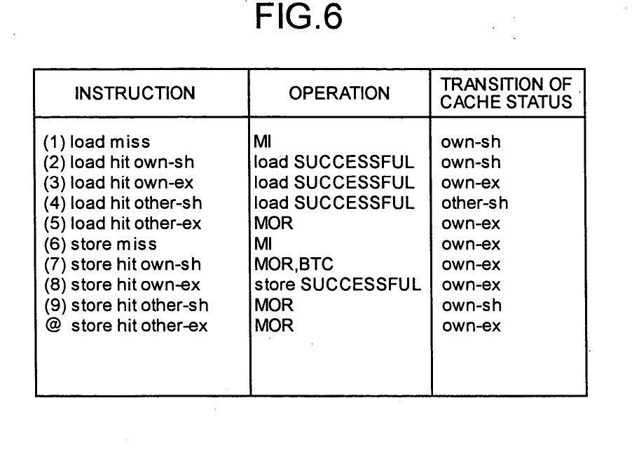

FIG. 6 is a drawing illustrating the operation of the cache controller 515 and shows the types of cache access operation according to the instruction using the cache line and the status of the cache line. There are ten access patterns that the cache controller 515 uses and three types of operations.

The first of the three operations come into effect when there is a cache miss (Cases 1 and 6). In this case, the cache controller 515 retrieves the cache line by making an MI request for the cache line to the secondary cache unit 550. If the cache line is required for loading data (case 1), the cache controller 515 registers the cache line as a shared cache line. If the cache line is required for storing data (case 6), the cache controller registers the cache line as an exclusive cache line.

The second operation comes into effect when the cache controller 515 has to carry out an operation for ensuring TSO between threads when a multi-thread operation is being executed (Cases 5, 7, 9, and @) and set the RIM flag and the RIF flag by MOR process. When performing a store on the cache line being shared by other processor cores (Case 7), the cache controller changes the status of the cache line from shared to exclusive (BTC), since if a store is performed on a shared cache line, it will be difficult to determine which processor core has the latest cache line. After the status of the cache line is changed to exclusive, the other processor cores use the area and carry out the MOR process to retrieve the cache line. The store operation is performed subsequently.

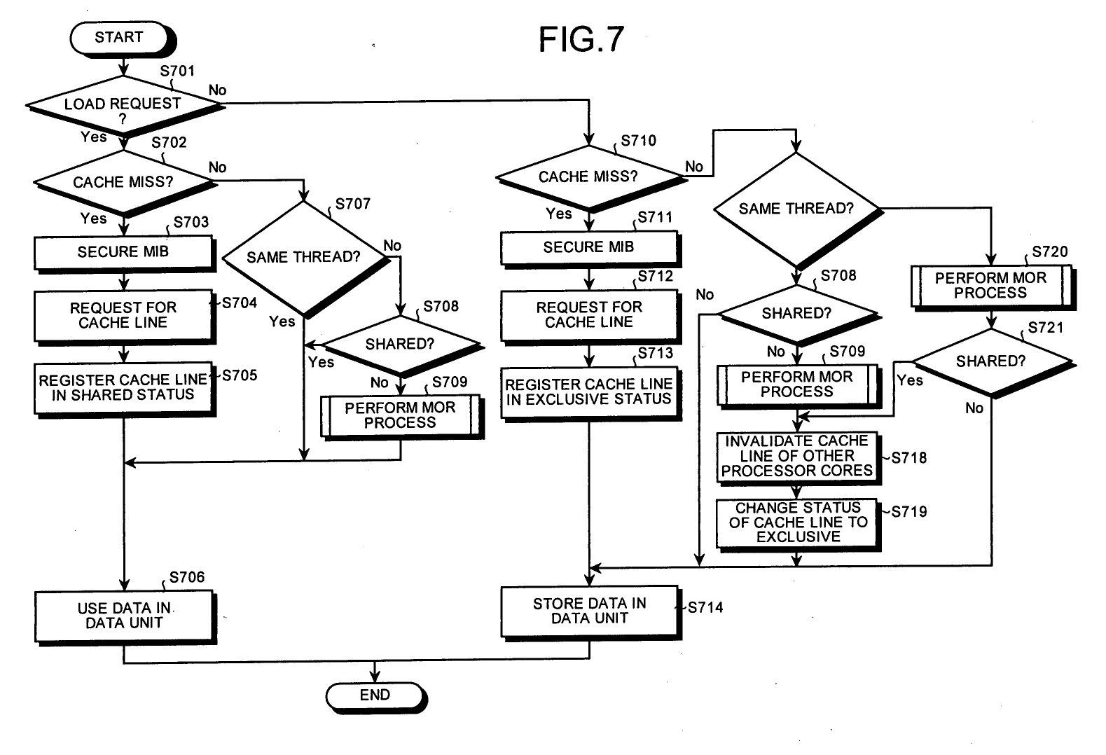

A process sequence of the cache controller 515 is explained next. FIG. 7 is a flowchart of the process sequence of the cache controller 515. The cache controller 515 first determines whether the request by the instruction unit 511 is for a load (step S701).

If the access is for a load (“Yes” at step S701), the cache controller 515 checks if there is a cache miss (step S702). If there is a cache miss, the cache controller 515 secures the MIB (step S703), and makes a request to the secondary cache unit 550 for the cache line (step S704). Once the cache line arrives, the cache controller 515 registers it as a shared cache line (step S705), and uses the data in the data unit (step S706).

However, if there is cache hit, the cache controller 515 determines whether the cache lines are registered by the same thread (step S707). If the cache lines are registered by the same thread, the cache controller 515 uses the data in the data unit (step S706). If the cache lines are not registered by the same thread, the cache controller 515 determines whether the cache line is shared (step S708). If the cache line is shared, the cache controller 515 uses the data in the data unit (step S706). If the cache line is exclusive, the cache controller performs the MOR process to set the RIM flag and the RIF flag (step S709), and uses the data in the data unit (step S706).

If the access is for a store (“No” at step S701), the cache controller 515 determines whether there is a cache miss (step S710). If there is a cache miss, the cache controller 515 secures the MIB (step S711) and makes a request to the secondary cache unit 550 for the cache line (step S712). Once the cache line arrives, the cache controller 515 registers the cache line as an exclusive cache line (step S713), and stores the data in the data unit (step S714).

However, if there is a cache hit, the cache controller 515 determines whether the cache lines are registered by the same thread (step S715). If the cache lines are registered by the same thread, the cache controller 515 determines whether the cache line is shared or exclusive (step S716). If the cache line is exclusive, the cache controller 515 stores the data in the data unit (step S714). If the cache line is shared, the cache controller 515 performs the MOR process to set the RIM flag and the RIF flag (step S717), invalidates the cache lines of the other processor cores (step S718), changes the status of the cache line to exclusive (step S719), and stores the data in the data unit (step S714).

If the cache lines are not registered by the same thread, the cache controller 515 performs the MOR process to set the RIM flag and the RIF flag (step S720), and determines whether the cache line is shared or exclusive (step S716). If the cache line is exclusive, the cache controller 515 stores the data in the data unit (step S714). If the cache line is shared, the cache controller 515 invalidates the cache lines of the other processor cores (step S718), changes the status of the cache line to exclusive (step S719), and stores the data in the data unit (step S714).

Thus, the TSO preservation mechanism between the processor cores can be used for ensuring TSO between the threads by monitoring the access of the cache memory or the main memory device by the cache controller 515 and performing the MOR process to set the RIM flag and the RIF flag if there is a possibility of a TSO violation.

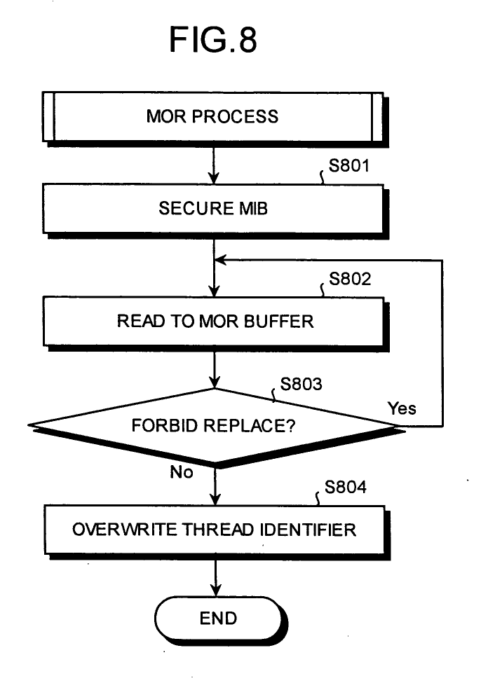

The MOR process is explained next. FIG. 8 is a flowchart of the process sequence of the MOR process. In the MOR process, the cache controller 515 first secures the MIB (step S801) and starts the replace move out operation. The cache controller 515 then reads half of the cache line to the replace move out buffer (step S802) and determines whether replace move out is forbidden (step S803). Replace move out is forbidden when special instructions such as compare and swap, etc. are used. When replace move out is forbidden, the data in the replace move out buffer is not used.

When replace move out is forbidden, the cache controller 515 returns to step S802, and re-reads the replace move out buffer. If replace move out is not forbidden, the cache controller reads the other half of the cache line into the replace move out buffer, and overwrites the thread identifier (step S804).

Thus, TSO is ensured between processor cores by the replace move out operation carried out by the MOR process, and the RIM flag is set at the fetch port where the PSTV flag is set using the same cache line on which replace move out is carried out. By setting the RIF flag along with the RIM flag, the mechanism for ensuring TSO between the processors can be used as a mechanism for ensuring TSO between the threads.

There are instances where different threads of the same processor core compete for the same cache line. In such cases, the process that comes into effect when different processors in a multi-processor environment compete for the same cache line becomes applicable.

To be specific, in a multi-processor environment, the processors have the control to prohibit throwing out of the cache line or to cause a forced invalidation of the cache line when the same cache line is sought by different processors. In other words, the processor that has the cache line stalls throwing out the cache line until the store process is completed. This stalling of throwing out of the cache line is called cache line throw out forbid control. If one processor continues the store on one cache line interminably, the cache line cannot be passed on to other processors. Therefore, if the cache line throw out process carried out by the cache line throw out request issued from another processor fails every time it is carried out in the cache pipeline, the store process to the cache line is forcibly terminated and the cache line is successfully thrown out. As a result, the cache line can be passed on to the other processor. If the store process continues even after the cache line has been passed on to the other processor, a cache line throw out request is sent to another processor. As a result, another cache line reaches the processor, and the store process can be continued.

The mechanism that comes into effect when different processors compete for the same cache line in a multi-processor environment also comes into effect during replace move out operation used when cache line is passed one between the threads. Therefore, no matter what the condition is, the cache line is successfully passed on and hanging is prevented.

Thus, in the second embodiment, the cache controller 515 of the primary data cache unit 514 monitors the access made to the cache memory or the main memory device, and if there is a possibility of a TSO violation, performs a MOR operation to set the RIM flag and the RIF flag. Consequently, the mechanism for ensuring TSO between the processors can be used as a mechanism for ensuring TSO between the threads.

The second embodiment is explained by taking a shared cache line shared between different threads. However, it is also possible to apply the second embodiment to the case where a shared cache line is controlled so that it behave like an exclusive cache line. To be specific, the MOR process can be performed when a load of a cache line registered by another thread is hit, thereby employing the mechanism for ensuring TSO between the processors as a mechanism for ensuring TSO between the threads.

The first and the second embodiments were explained by taking the instruction unit as executing two threads concurrently. However, the present invention can also be applied to cases where the instruction unit processes three or more threads.

A concurrent multi-thread method is explained in the first and the second embodiments. A concurrent multi-thread method refers to a method where a plurality of threads are processed concurrently. There is another multi-thread method, namely, time sharing multi-thread method in which when execution of an instruction is stalled for a specified duration or due to a cache miss the threads are switched. Ensuring TSO preservation using the time sharing multi-thread method is explained next.

The threads are switched in the time sharing multi-thread method by making the thread being executed inactive and starting up another thread. During the switching of the threads, all the fetch instructions and store instructions that are not committed and are issued from the thread being inactivated are cancelled. TSO violation that can arise from the store of another thread can be prevented by canceling the fetch instructions and store instructions that are not committed

The store instructions that are committed execute serial store once they become executable after being stalled at the store port that have store requests and store data or the write buffer until the cache memory or the main memory device allow data to be written to them. When an earlier store must reflect on a later fetch, that is, when a memory area to which data is stored earlier has to be fetched later, the address and the operand length of the store request is detected by comparing the address and the operand length of the fetch request. In such a case fetch is stalled until the completion of store by Store Fetch Interlock (SFI).

Thus, even if switching of threads occurs after the store instructions are committed, and store of different threads build up in the store port, the influence of store by different threads can be made to reflect by SFI. Consequently, TSO violation resulting from store of different threads during thread inactivation can be avoided.

Further, TSO can be ensured between processors by setting the RIM flag by cache line invalidation/throwing out, and the RIF flag by the arrival of the data. Consequently, by ensuring TSO between different threads, TSO can be ensured in the entire computer system.

Thus, according to the present invention, when data in the address specified in the memory access request is being stored, it is determined whether the thread that has registered the data being stored and the thread that has issued the memory access request are the same. Based on the determination, a coherence ensuring mechanism comes into effect that ensures coherence in the sequence of execution of read and write of the data shared between a plurality of instruction processors. Consequently, the coherence in the sequence of execution of write and read of the data between the threads can be ensured.

According to the present invention, when a cache line that includes the data in the address specified in the memory access request is being stored, it is determined whether the thread that has registered the cache line being stored and the thread that has issued the memory access request are the same. If the threads are not the same, a coherence ensuring mechanism comes into effect that ensures coherence in the sequence of execution of read and write of the data shared between a plurality of instruction processors. Consequently, the coherence in the sequence of execution of write and read of the data between the threads can be ensured.

According to the present invention, the primary data cache device makes a retrieve cache line request to the secondary cache device when the cache line that has the same physical address as that of the cache line for which memory access request is issued by the instruction processor is registered by a different thread. If the cache line for which retrieve request is made is registered in the primary data cache device by a different thread, the secondary cache device makes a cache line invalidate or cache line throw out request to the primary data cache device. The primary data cache device invalidates or throws out the cache line based on the request by the secondary cache device. Consequently, coherence ensuring mechanism is brought into effect that ensures coherence between the sequence of execution of reading from the cache line and writing to the cache line by the plurality of instruction processors when the cache line is shared with the primary data cache devices belonging to other sets. As a result, the coherence in the sequence of execution of write and read of the data between the threads can be ensured.

According to the present invention, when switching the threads executed by the instruction processor, all the store instructions and fetch instructions that are not committed by the thread that is to be made inactive are invalidated. Once the inactive thread is reactivated, all the fetch instructions that are influenced by the execution of the committed store instructions are detected. The execution of instruction is controlled in such a way that the detected fetch instructions are executed after the store instructions. As a result, the coherence in the sequence of execution of write and read of the data between the threads can be ensured.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

1. A memory control device that is shared by a plurality of threads that are concurrently executed, and that processes memory access requests issued by the threads, the memory control device comprising:
a coherence ensuring unit that ensures coherence of a sequence of execution of reading and writing of data by a plurality of instruction processors, wherein the data is shared between the instruction processors;
a thread determining unit that, when storing data belonging to an address specified in the memory access request, determines whether a first thread and a second thread are the same, wherein the thread is a thread that has registered the data and the second thread is a thread that has issued the memory access request; and
a coherence ensuring operation launching unit that activates the coherence ensuring unit based on a determination result of the thread determining unit.

2. The memory control device according to claim 1, wherein the coherence ensuring operation launching unit makes to a lower-level memory control device a data retrieval request when the thread determining unit determines that the first thread and the second thread are not the same, and activates the coherence ensuring unit based on an instruction issued by the lower-level memory control device in response to the data retrieval request.

3. The memory control device according to claim 1, wherein the coherence ensuring operation launching unit activates the coherence ensuring unit by executing a data throw out operation in a lower-level memory control device when the thread determining unit determines that the first thread and the second thread are not the same.

4. The memory control device according to claim 1, wherein the coherence ensuring operation launching unit activates the coherence ensuring unit by a cache line switching operation based on the determination result of the thread determining unit and a sharing status of the data between the instruction processors.

5. The memory control device according to claim 1, wherein the coherence ensuring unit ensures coherence by monitoring invalidation of the data belonging to the address or throwing out the data to and retrieving the data from another storage control device.

6. The memory control device according to claim 5, wherein the coherence ensuring unit monitors the invalidation of the data belonging to the address, or throwing out the data to and retrieving the data from another storage control device with the aid of a PSTV flag, a RIM flag, and a RIF flag set at a fetch port.

7. A data cache control device that is shared by a plurality of threads that are concurrently executed and that processes memory access requests issued by the threads, the data cache control device comprising:
a coherence ensuring unit that ensures coherence of a sequence of execution of reading and writing of data by a plurality of instruction processor, wherein the data is shared between the instruction processors;
a thread determining unit that, when storing a cache line that includes data belonging to an address specified in the memory access request, determines where a first thread and a second thread are the same, wherein the first thread is a thread that has registered the cache line and the second thread is a thread that has issued the memory access request; and
a coherence ensuring operation launching unit that actives the coherence ensuring unit when the thread determining unit determines that the first thread and the second thread are not the same.

8. The data cache control device according to claim 7, wherein the thread determining unit determines whether the first thread and the second thread are the same based on a thread identifier set in a cache tag.

9. A central processing device that includes a plurality of sets of instruction processors that concurrently execute a plurality of threads and primary data cache devices, and a secondary cache device that is shared by the primary data cache devices belonging to different sets, wherein each primary data cache device comprises:
a coherence ensuring unit that ensures coherence in a sequence of execution of reading from the cache line and writing to the cache line by the plurality of instruction processors, the cache line being shared with the primary data cache devices belonging to other sets;
a retrieval request unit that makes to the secondary cache device a cache line retrieval request when the cache line belonging to a physical address that matches with the physical address in the memory access request from the instruction processor; and
a throw out execution unit that activates the coherence ensuring unit by invalidating or throwing out the cache line based on a request from the secondary cache device, and
wherein the secondary cache device includes a throw out requesting unit that, when the cache line retrieval request is registered in the primary data cache device by another thread, makes to the primary data cache device the request to invalidate or throw out the cache line.

10. A memory control device that is shared by a plurality of threads that are concurrently executed and that processes memory access requests issued by the threads, the memory control device comprising:
an access invalidating unit that, when the instruction processor switches threads, invalidates from among store instructions and fetch instructions issued by the thread being inactivated, all the store instructions and fetch instructions that are not committed; and
an interlocking unit that, when the inactivated thread is reactivated, detects the fetch instructions that are influenced by the execution of the committed store instructions, and exerts control in such a way that the detected fetch instructions are executed after the store instructions.

11. A memory device control method for processing memory access requests issued from concurrently executed threads, the memory device control method comprising:
determining, when storing data belonging to an address specified in the memory access request, whether a first thread is the same as a second thread, wherein the first thread is a thread that has registered the data and the second thread is a thread that has issued the memory access request; and
activating a coherence ensuring mechanism that ensures coherence in a sequence of execution of reading and writing of the data by a plurality of instruction processors, wherein the data is shared between the instruction processors.

12. The memory device control method according to claim 11, wherein the activating includes making to a lower-level memory control device a data retrieval request when the first thread and the second thread are not found to be the same in the determining, and activating the coherence ensuring mechanism based on an instruction issued by the lower-level memory control device in response to the data retrieval request.

13. The memory device control method according to claim 11, wherein the activating includes activating the coherence ensuring mechanism by executing a data throw out operation in a lower-level memory control device when the first and the second thread are not found to be the same in the thread determining step.

14. The memory device control method according to claim 11, wherein the activating includes activating the coherence ensuring mechanism by a cache line switching operation based on a determination result in the thread determining step and a sharing status of the data between the instruction processors.

15. The memory device control method according to claim 11, wherein the activating includes ensuring coherence by monitoring invalidation of the data belonging to the address or throwing out the data to and retrieving the data from another storage control device.

16. The memory device control method according to claim 15, wherein the activating includes monitoring the invalidation of the data belonging to the address, or throwing out the data to and retrieving the data from another storage control device with the aid of a PSTV flag, a RIM flag, and a RIF flag set at a fetch port.

17. A data cache control method for processing memory access requests issued from concurrently executed threads, the data cache control method comprising:
determining, when storing a cache line that includes data belonging to an address specified in the memory access request, whether a first thread is the same as a second thread, wherein the first thread is a thread that has registered the cache line and the second thread is a thread that has issued the memory access request; and
activating a coherence ensuring mechanism that ensures coherence in a sequence of execution of reading and writing of the data by a plurality of instruction processors, wherein the data is shared between the instruction processors.

18. The data cache control method according to claim 17, wherein the determining includes determining whether the first thread and the second thread are the same based on a thread identifier set in a cache tag.

19. A cache control method used by a central processing device that includes a plurality of sets of instruction processors that concurrently execute a plurality of threads and primary data cache devices, and a secondary cache device that is shared by the primary data cache devices belonging to different sets, the cache control method comprising:
each of the primary data cache device making to the secondary cache device a cache line retrieval request when the cache line belonging to a physical address that matches with the physical address in the memory access request from the instruction processor;
the secondary cache device performing throwing-out, when the cache line retrieval request is registered in the primary data cache device by another thread, the secondary cache device makes to the primary cache device a request to invalidate or throw out the cache line; and
the primary data cache device activating, by invalidating or throwing out the cache line based on the request from the secondary cache device, the coherence ensuring mechanism that ensures coherence of a sequence of execution of reading of and writing to the cache line by a plurality of instruction processors, the cache line being shared by the primary data cache device belonging to other sets.

20. A data cache control method for processing memory access requests issued from concurrently executed threads, the memory device control method comprising:
invalidating, when the instruction processor switches threads, from among store instructions and fetch instruction issued by the thread being inactivated, all the store instructions and fetch instructions that are not committed; and
detecting, when the inactivated thread is reactivated, the fetch instructions that are influenced by the execution of the committed store instructions, and executing control in such a way that the detected fetch instructions are executed after the store instructions.
